(19) United States
(12) Patent Application Publication
(10) Pub. No.: US 2026/0025774 A1
(43) Pub. Date: Jan. 22, 2026

(54) METHOD FOR DETERMINING TA, COMMUNICATION DEVICE, AND CHIP

(71) Applicant: GUANGDONG OPPO MOBILE TELECOMMUNICATIONS CORP., LTD., Dongguan (CN)

(72) Inventors: Haitao LI, Dongguan (CN); Yi HU, Dongguan (CN)

(21) Appl. No.: 19/340,366

(22) Filed: Sep. 25, 2025

Related U.S. Application Data
(63) Continuation of application No. PCT/CN2023/101954, filed on Jun. 21, 2023.

(51) Int. Cl. H04W 56/00; H04B 7/185; H04B 17/318

(52) U.S. Cl. CPC H04W 56/0045; H04B 7/1851; H04B 17/318

(57) ABSTRACT

Provided is a method for determining a first TA. The method may be applicable to a terminal device. The method includes: determining a first TA based on a free-space path loss between a terminal and a satellite, and the first TA includes a TA for a service link, wherein the TA for the service link is acquired based on the free-space path loss between the terminal and the satellite.

### CROSS-REFERENCE TO RELATED APPLICATION

This application is a continuation of International Application No. PCT/CN2023/101954, filed Jun. 21, 2023, the entire disclosure of which is incorporated herein by reference.

### TECHNICAL FIELD

The present disclosure relates to the technical field of communications, and in particular, relates to a method and apparatus for determining a TA, and a communication device and a chip therefor.

### RELATED ART

In a new radio (NR) system, to ensure the orthogonality of uplink transmission, network devices require that signals transmitted from different terminals using different frequency-domain resources at the same time arrive at the network devices in a basically time-aligned manner.

### SUMMARY

Embodiments of the present disclosure provide a method for determining a timing advance (TA), and a communication device and a chip therefor. The technical solutions are as follows:

According to an aspect of the embodiments of the present disclosure, a method for determining a TA is provided. The method includes: determining a first TA based on a free-space path loss between a terminal and a satellite.

According to an aspect of the embodiments of the present disclosure, a communication device for determining a TA is provided. The communication device includes: a processor and a memory storing at least one segment of program; wherein the processor is configured to execute the at least one segment of program in the memory to determine a first TA based on a free-space path loss between a terminal and a satellite.

According to an aspect of the embodiments of the present disclosure, a chip is provided. The chip includes programmable logical circuitry or one or more programs. The chip, when running, causes the chip to perform the method for determining a TA.

### BRIEF DESCRIPTION OF DRAWINGS

For clearer descriptions of the technical solutions according to the embodiments of the present disclosure, the following briefly introduces the accompanying drawings require for describing the embodiments. Apparently, the accompanying drawings in the following description show merely some embodiments of the present disclosure, and persons of ordinary skill in the art may still derive order drawings from these accompanying drawing without creative efforts.

FIG. 1 is a network architecture diagram of a transparent payload NTN according to some embodiments of the present disclosure;

FIG. 2 is a network architecture diagram of a regenerative payload NTN according to some embodiments of the present disclosure;

FIG. 3 is a timing relationship diagram of an NTN system according to some embodiments of the present disclosure;

FIG. 4 is a timing relationship diagram of an NTN system according to some embodiments of the present disclosure;

FIG. 5 is a schematic diagram of a contention-based random access procedure according to some embodiments of the present disclosure;

FIG. 6 is a schematic diagram of a non-contention-based random access procedure according to some embodiments of the present disclosure;

FIG. 7 is a schematic diagram of a method for determining an initial TA according to some embodiments of the present disclosure;

FIG. 8 is a flowchart of a method for determining a TA according to some embodiments of the present disclosure;

FIG. 9 is a flowchart of a method for determining a TA according to some embodiments of the present disclosure;

FIG. 10 is a flowchart of a method for determining a TA according to some embodiments of the present disclosure;

FIG. 11 is a block diagram of an apparatus for determining a TA according to some embodiments of the present disclosure; and

FIG. 12 is a structural schematic diagram of a communication device according to some embodiments of the present disclosure.

### DETAILED DESCRIPTION

To make the objectives, technical solutions, and advantages of the present disclosure clearer, the implementations of the present disclosure are described in further detail hereinafter with reference to the accompanying drawings. Exemplary embodiments are described in detail herein, and examples thereof are illustrated in the accompanying drawings. When the following description refers to the accompanying drawings, like reference numerals in different drawings denote like or similar elements unless otherwise indicated. The implementations described in the following exemplary embodiments do not represent all implementations consistent with the present disclosure. On the contrary, these implementations are merely examples of apparatuses and methods consistent with some aspects of the present disclosure as detailed in the appended claims.

The network architectures and service scenarios described in the embodiments of the present disclosure are intended to more clearly illustrate the technical solutions of the embodiments of the present disclosure, and do not constitute limitations on the technical solutions according to the embodiments of the present disclosure. Those of ordinary skill in the art will appreciate that with the evolution of network architectures and the emergence of new service scenarios, the technical solutions provided by the embodiments of the present disclosure are equally applicable to similar technical problems. The terms used in the present disclosure are for the purpose of describing particular embodiments only and are not intended to limit the present disclosure. As used in the present disclosure and the appended claims, the singular forms “a,” “an” and “the” are intended to include the plural forms as well, unless the context clearly indicates otherwise. It should also be understood that the term “and/or” as used herein refers to and includes any and all possible combinations of one or more of the associated listed items.

It should be understood that although the terms “first,” “second,” and the like may be used in the present disclosure to describe various information, such information should not be limited to these terms. These terms are only used to distinguish one type of information from another. For example, without departing from the scope of this disclosure, a first parameter could also be referred to as a second parameter, and similarly, a second parameter could also be referred to as a first parameter. Depending on the context, the word “if” as used herein may be interpreted as “when” or “upon” or “in response to determining.”

Currently, the 3^{rd} Generation Partnership Project (3GPP) is researching non-terrestrial network (NTN) technology, which generally adopts satellite communications to provide communication services to ground users. Compared with terrestrial cellular network communication, satellite communication has many unique advantages. First, satellite communication is not restricted by the geographic location of a user. For example, ordinary terrestrial communications my not cover areas such as oceans, high mountains, and deserts where communication devices may not be set up or communication coverage is not provided due to sparse population. However, for satellite communications, since a single satellite covers a large area of the ground, and in addition, satellites may move in orbits around the Earth, and theoretically every corner of the Earth may be covered by satellite communication. Second, satellite communication has great social value. Satellite communication covers remote mountainous areas, poor and backward countries or regions at a relatively low cost, enabling people in these areas to enjoy advanced voice communications and mobile Internet technologies, which is conducive to narrowing the digital divide with developed areas and promoting the development of these regions. Third, satellite communication has a long distance, and the cost of communication does not increase significantly as the communication distance increases. Finally, satellite communication has high stability and is not restricted by natural disasters.

Communication satellites are classified into low-Earth orbit (LEO) satellites, medium-Earth orbit (MEO) satellites, geostationary Earth orbit (GEO) satellites, high elliptical orbit (HEO) satellites according to their orbital altitudes. At the current stage, the main research focuses on LEO and GEO.

### 1. LEO

LEO satellites have an altitude range of 500 km to 1500 km, with a corresponding orbital period of approximately 1.5 to 2 hours. The signal propagation delay for single-hop communication between users is generally less than 20 ms. The maximum satellite visibility time is 20 minutes. The signal propagation distance is short, the link loss is small, and the requirements for the transmit power of user terminals are not stringent.

### 2. GEO

GEO satellites have an orbital altitude of 35786 km and an orbital period of 24 hours around the Earth. The signal propagation delay for single-hop communication between users is generally 250 ms.

To ensure the satellite coverage and improve the system capacity of the entire satellite communication system, satellites adopt multi-beam coverage for the ground. A single satellite is capable of forming dozens or even hundreds of beams to cover the ground; and a satellite beam is capable of covering cover a ground area with a diameter of tens to hundreds of kilometers.

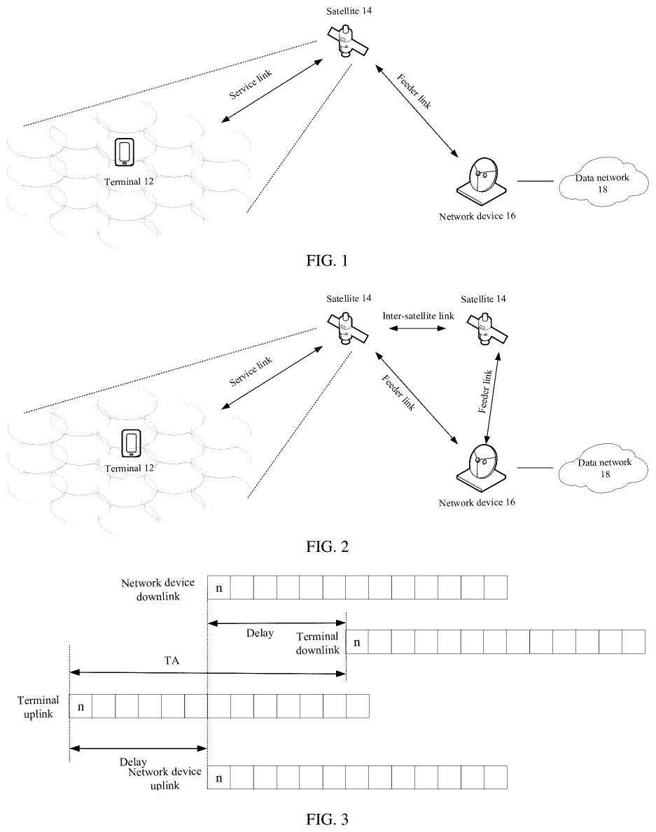

There are at least two NTN scenarios: a transparent payload NTN scenario and a regenerative payload NTN scenario. FIG. 1 illustrates the transparent payload NTN scenario, and FIG. 2 illustrates the regenerative payload NTN scenario.

The NTN network consists of the following network elements:
One or more gateways, configured to be connected to a satellite and a terrestrial public network.
Feeder link: used for communication between a gateway and a satellite.
Service link: used for communication between a terminal and a satellite.
Satellites: categorized into two types in terms of functionality: transparent payload satellites and regenerative payload satellites.
Transparent payload: only providing functions of radio frequency filtering, frequency conversion and amplification. The transparent payload only provides transparent forwarding of signals without changing waveforms of the forwarded signals.
Regenerative payload: in addition to providing functions of radio frequency filtering, frequency conversion and amplification, further providing functions of demodulation/decoding, routing/switching, and encoding/modulation. The regenerative payload has part or all of functions of a network device.
Inter-satellite links (ISL): present in the regenerative payload scenario.

To ensure time synchronization on the network devices, the NR system supports a timing advance (TA) mechanism for uplink.

A terminal with positioning capabilities usually estimates a TA value for a service link based on terminal position information and ephemeris information, and thus uses the TA value for TA pre-compensation during the uplink transmission.

However, a current method for estimating a TA value relies on the positioning capabilities of the terminal. Because some terminals do not have the positioning capabilities, or the positions of the terminals may not be acquired based on the positioning capabilities, the terminals are unable to determine TA values without relying on the positioning capabilities.

As schematically illustrated in FIG. 1 and FIG. 2, in the two NTN scenarios, a network device 16 may be a base station, which is a device providing wireless communication functions for terminals. The base station may be in any form, such as a macro base station, a micro base station, a relay station, an access point. In systems using different radio access technologies, the names of devices with the functions of the base station may vary. For example, in a long-term evolution (LTE) system, the devices with the functions of the base station are called eNodeBs or eNBs; and in a 5G new radio-unlicensed (NR-U) system, the devices the functions of the base station are called gNodeBs or gNBs. With the evolution of communication technologies, the description of “base station” may vary. In the embodiments of the present disclosure, the devices that provide wireless communication functions for a terminal 14 are collectively referred to as network devices.

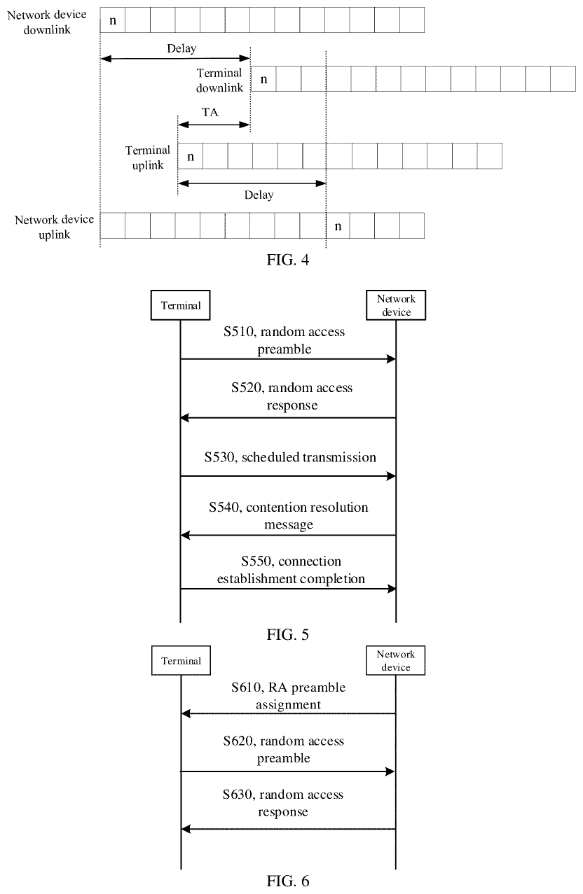

In an NTN system, a terminal needs to consider the impact of TA during uplink transmission. Due to the large propagation delay in the system, the range of TA values is also relatively large. In a case where the terminal is scheduled for uplink transmission in slot n, the terminal considers the round-trip propagation delay and advances its uplink transmission, such that the signal arrives at the network device within uplink slot n. Specifically, a timing relationship in the NTN system may include two cases, as illustrated in FIG. 3 and FIG. 4 hereinafter respectively.

Case 1 is illustrated in FIG. 3. Similar to the NR terrestrial network, downlink and uplink slots at the network device are aligned. Correspondingly, in order to align the uplink transmission of the terminal with the uplink slots at the network device, the terminal needs to use a larger TA value. During the uplink transmission, a larger offset parameter k_{offset} also needs to be applied.

Case 2 is illustrated in FIG. 4. A timing offset is present between the downlink and uplink slots at the network device. In this case, where the uplink transmission of the terminal is to be aligned with the uplink slots at the network device, the terminal only needs to use a smaller TA value. However, in this case, the network device may require additional scheduling complexity to handle the corresponding scheduling timing.

All terminals in the NTN scenario are equipped with global navigation satellite system (GNSS) positioning capabilities and TA pre-compensation capabilities, that is, the terminal may determine a TA corresponding to the service link based on the GNSS positioning capabilities and the ephemeris information of a serving satellite. The terminal may determine the TA in accordance with the following formula:

$${T}_{T A} = ( {N}_{T A} + {N}_{TA , UE - Specific} + {N}_{TA , common} + {N}_{TA , offset} ) \times {T}_{C}$$

In the formula, N_{TA} is updated based on a TAC issued by the network; N_{TA,UE-Specific} represents a TA corresponding to the service link estimated by the terminal (user equipment, UE); N_{TA,common} represents a public TA broadcast by the network; and N_{TA,offset} represents a fixed offset value.

The timing relationship in the existing NR system is as follows:

Reception timing of a physical downlink shared channel (PDSCH): In a case where a terminal is scheduled by downlink control information (DCI) to receive a PDSCH, the DCI includes indication information of K0, which is used to determine a slot for transmitting the PDSCH. For example, in a case where the scheduling DCI is received in slot n, the slot allocated for PDSCH transmission is slot

$$[ n \frac{{2}_{PDSCH}^{μ}}{{2}_{PDCCH}^{μ}} ] + K 0.$$

K0 is determined according to a subcarrier spacing of the PDSCH. μ_{PDSCH} and μ_{PDSCH} are used to determine subcarrier spacings configured for the PDSCH and a physical downlink control channel (PDCCH) respectively. The numerical range of K0 is 0 to 32.

Transmission timing of a physical uplink shared channel (PUSCH) scheduled by DCI: In a case where a terminal is scheduled by the DCI to transmit the PUSCH, the DCI contains indication information of K2, which is used to determine a slot for transmitting the PUSCH. For example, if the scheduling DCI is received in slot n, the slot allocated for PUSCH transmission is slot

$$[ n \frac{{2}_{PDSCH}^{μ}}{{2}_{PDCCH}^{μ}} ] + K 2.$$

K2 is determined based on a subcarrier spacing for the PDSCH. μ_{PDSCH} and μ_{PDSCH} are used to determine subcarrier spacings configured for the PDSCH and the PDCCH respectively. The value numerical of K2 is 0 to 32.

Transmission timing of a PUSCH scheduled by a random access response (RAR) grant: For the slot in which PUSCH transmission is scheduled by the RAR grant, in a case where the terminal initiates physical random access channel (PRACH) transmission, an end position of the PDSCH containing a corresponding RAR grant received by the terminal is located in slot n, then the terminal transmits the PUSCH in slot n+K2+Δ. K2 and Δ are stipulated in the protocol.

Transmission timing of a hybrid automatic repeat request acknowledgment (HARQ-ACK) on a PUCCH: For the slot for PUCCH transmission, in a case where an end position of PDSCH reception is located in slot n or an end position of PDCCH reception indicating release of a semi-persistent scheduling (SPS) PDSCH is located in slot n, the terminal shall transmit a corresponding HARQ-ACK on the PUCCH resource within slot n+K1. K1 represents the number of slots and is indicated by the PDSCH-to-HARQ-timing-indicator field in a DCI format, or provided by the dl-DataToUL-ACK parameter. K1=0 means that the last slot of PUCCH transmission is overlapped with the slot of PDSCH reception or the PDCCH reception indicating release of the SPS PDSCH.

Activation timing of a medium access control (MAC) control element (CE): In a case where an HARQ-ACK corresponding to the PDSCH containing a MAC CE command is transmitted in slot n, a corresponding behavior indicated by the MAC CE command and a downlink configuration assumed by the terminal shall take effect from the first slot following the slot

$$n + 3 {N}_{slot}^{subframe , μ} , wherein {N}_{slot}^{subframe , μ}$$

represents the number of slots included in each subframe under a subcarrier spacing configuration μ.

Transmission timing of channel state information (CSI) on a PUSCH: A timing of CSI transmission on the PUSCH is the same as the timing of PUSCH transmission scheduled by the DCI under normal circumstances.

Timing of CSI reference resources: For CSI reported in uplink slot n′, a CSI reference resource is determined based on a single downlink slot

$$n - {n}_{CSI\_ref} \cdot n = [ {n}^{′} \frac{{2}_{DL}^{μ}}{{2}_{DL}^{μ}} ] \cdot {μ}_{DL}$$

and μ_{UL} represent subcarrier spacing configurations for downlink and uplink respectively. The value of n_{CSI_ref} depends on the type of a CSI report.

Transmission timing of an aperiodic SRS: In a case where a terminal receives DCI triggering transmission of the aperiodic SRS in slot n, the terminal (UE) transmits the aperiodic SRS in each triggered SRS resource set in slot

$${n {2}_{PDCCH}^{μ} + k .}^{\underline{{μ}_{SRS}}}$$

k is configured based on the high-layer parameter Slot Offset in each triggered SRS resource set and is determined based on a subcarrier spacing corresponding to the triggered SRS transmission. μ_{SRS} and μ_{PDCCH} represent subcarrier spacing configurations for the triggered SRS transmission and the PDCCH carrying a trigger command respectively.

The NR random access procedure refers to the process from when a terminal transmits a random access preamble to attempt to access the network until a basic signaling connection is established with the network. This procedure allows the terminal to establish data communication with the network side.

The random access procedure is mainly triggered by at least one of the following events:
Establishing a radio connection during initial access of the UE: the UE switches from the RRC_IDLE (i.e., idle network) state to the RRC_CONNECTED (i.e., connected network) state.
Radio resource control (RRC) connection reestablishment process: this process allows the UE to reestablish a radio connection in response to a radio link failure.
Handover: the UE needs to establish synchronous uplink transmission with a new cell.
In the RRC_CONNECTED state, downlink (DL) data arrives and uplink (UL) is in an out-of-sync state.
In the RRC_CONNECTED state, UL data arrives and the UL is in an out-of-sync state or there are no PUCCH resources for transmitting a scheduling request (SR).
SR transmission failure.
Receiving a synchronization reconfiguration request from RRC.
The UE transitions from the RRC_INACTIVE (i.e., network inactive) state to the RRC_CONNECTED state.
Establishing time alignment during the secondary cell (SCell) addition process.
Requesting other serial interfaces (SI).
Beam failure recovery.

In NR Rel-15, two main types of random access procedures are supported, namely, a type-1 random access procedure and a type-2 random access procedure.

1. Type-1 is a contention-based random access procedure (the first four steps constitute the random access procedure). Illustratively, as illustrated in FIG. 5, which presents a schematic diagram of the contention-based random access procedure according to some embodiments of the present disclosure, the method includes the following steps.

In S510, a terminal transmits Msg1 (i.e., a random access preamble) to a network device.

The terminal transmits a selected random access preamble on time-frequency resources of a selected PRACH. The network device may estimate an uplink timing and a grant size required for the terminal to transmit Msg3 based on the random access preamble.

In S520, the network device transmits Msg2 (i.e., an RAR) to the terminal.

Upon transmitting Msg2, the terminal starts an RAR window, and monitors a PDCCH within the RAR window. The PDCCH is scrambled with a random access radio network temporary identifier (RA-RNTI).

Subsequent to successfully monitoring the PDCCH scrambled with RA-RNTI, the terminal is capable of acquiring a PDSCH scheduled by the PDCCH, wherein the PDSCH contains the RAR.

The RAR includes: a backoff indicator (BI), used to indicate the backoff time for retransmitting Msg1; a random access preamble identifier (RAPID), used to indicate the random access preamble; a timing advance group (TAG), used to adjust the uplink timing; an uplink grant (UL grant), used to schedule the indication of uplink resources for Msg3; a temporary cell-radio network temporary identity (temporary C-RNTI), used to scramble the PDCCH of Msg4 (initial access).

In S530, the terminal transmits Msg3 (i.e., scheduled transmission (ST)) to the network device.

Msg3 is mainly used to inform the network device of an event that triggers a random access procedure. Illustratively, in a case where the event is an initial access random procedure, Msg3 carries a user equipment identifier (UE ID) and an establishment cause; or in a case where the event is RRC reestablishment, Msg3 carries a connected-mode UE identifier and an establishment cause.

In S540, the network device transmits Msg4 (i.e., a contention resolution message) to the terminal.

Msg4 has two functions. First, Msg4 may be used to resolve contention conflicts. Second, Msg4 is a message via which the network device transmits RRC configurations to the terminal.

Resolving contention conflicts means that the terminal receives the PDSCH of Msg4 and performs scheduling by matching a common control channel signal distribution unit (CCCH SDU) in the PDSCH. There are two scenarios for acquiring the PDSCH:
1. In a case where the terminal carries a C-RNTI in Msg3, Msg4 is scheduled using a PDCCH scrambled with the C-RNTI;
2. In a case where the terminal does not carry the C-RNTI in Msg3 (e.g., the current random access procedure is an initial access), Msg4 is scheduled using a PDCCH scrambled with a temporary C-RNTI.

In S550, the terminal transmits Msg5 (i.e., a connection establishment complete message) to the network device.

Msg5 is mainly used to inform the network device that the connection establishment of the random access is complete.

2. Type-1 random access procedure (two-step random access procedure).

In the contention-based random access procedure, the 4-step random access procedure may also be merged into a 2-step random access procedure. The merged 2-step random access procedure includes MsgA and MsgB, with the relevant steps as follows:

In S1, the terminal transmits MsgA to the network device.

In S2, upon receiving MsgA from the terminal, the network device transmits MsgB to the terminal.

Optionally, MsgA includes the contents of Msg1 and Msg3, that is, MsgA includes: a random access preamble and a UE ID. The UE ID may be one of: a C-RNTI, a temporary C-RNTI, an RA-RNTI, or a non-access stratum (NAS) UE ID. Optionally, MsgB includes the contents of Msg2 and Msg4. That is, MsgB includes: a random access response and a contention resolution message.

3. Type-2 is a contention-free random access procedure (three-step random access procedure). Illustratively, referring to FIG. 6, which illustrates a schematic diagram of a contention-free random access procedure according to some embodiments of the present disclosure, the method includes the following steps.

In S610, the network device transmits Msg1 (i.e., an RA preamble assignment) to the termina.

In S620, the terminal transmits Msg2 (i.e., a random access preamble) to the network device.

The terminal transmits the selected random access preamble on the time-frequency resources of the selected PRACH. The PRACH and preamble may be specified by the network device, which may estimate the uplink timing and the grant size required for the terminal to transmit Msg3 based on the random access preamble.

In S630, the network device transmits Msg3 (i.e., an RAR) to the terminal.

Upon transmitting Msg1, the terminal starts an RAR window. Within the RAR window, the terminal monitors the PDCCH. The PDCCH is scrambled with the RA-RNTI.

Subsequent to successfully monitoring the PDCCH scrambled with the RA-RNTI, the terminal may acquire the PDSCH scheduled by the PDCCH, and the PDSCH contains the RAR.

The RAR includes: a BI, used to indicate the backoff time for retransmitting Msg1; a RAPID, used to indicate the random access preamble; a TAG, used to adjust the uplink timing; an UL grant, used to schedule the indication of uplink resources for Msg3; a temporary C-RNTI, used to scramble the PDCCH of Msg4 (initial access).

As seen from the above random access procedure, the main purpose of random access is to enable the terminal to achieve uplink synchronization with the network device. During the random access procedure, the network device may know the time when the terminal transmits the preamble based on the PRACH used by the terminal to transmit the preamble, thereby determining the initial TA for the terminal according to the transmit time and receive time of the preamble, and informing the terminal through the RAR.

It is worth noting that the above-mentioned “Msg1,” “Msg2,” “Msg3,” “Msg4,” and “Msg5” are only examples, and the numbering of messages is not limited in the present disclosure.

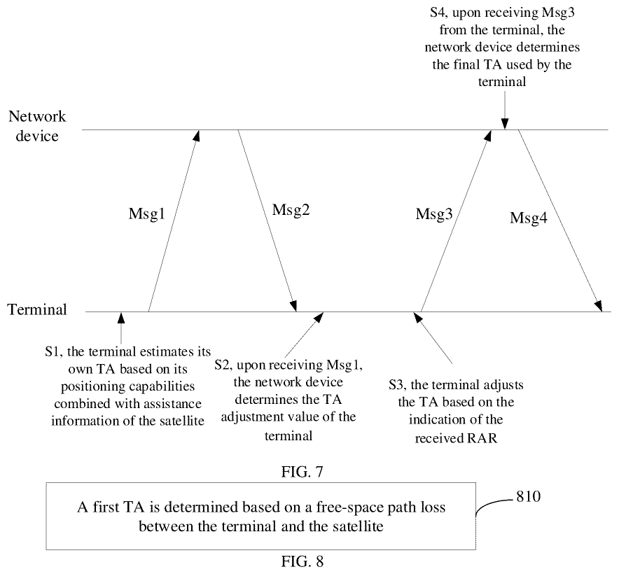

The method for determining the initial TA in the NTN system is described hereinafter. Illustratively, referring to FIG. 7, which illustrates a schematic diagram of a method for determining the initial TA according to some embodiments of the present disclosure, the method includes the following steps. Currently, the NTN system requires the terminal to have positioning capabilities.

In S1, the terminal estimates its own TA based on its positioning capabilities combined with assistance information of the satellite, and uses the self-estimated TA to perform time-domain pre-compensation to transmit Msg1.

The TA value estimated by the terminal is

$${T}_{TA} = ( {N}_{TA} + {N}_{TAoffset} + {N}_{TA , adj}^{common} + {N}_{TA , adj}^{UE} ) {T}_{c} \cdot {N}_{TA , adj}^{UE}$$

represents the TA for the service link calculated by the terminal according to its own position and ephemeris information of the satellite. During transmission of Msg1, N_{TA}=0. N_{TAoffset} represents a value broadcast by the network device.

$${N}_{TA , adj}^{common}$$

is calculated through parameters broadcast by the network device, and its actual meaning is the TA value between the satellite and the reference point RP.

In S2, upon receiving Msg1, the network device determines the TA adjustment value of the terminal and indicates the TA adjustment value of the terminal to the terminal via Msg2.

In S3, the terminal adjusts the TA based on the indication of the received RAR, and transmits Msg3 on the uplink resources scheduled by the network device.

In S4, upon receiving Msg3 from the terminal, the network determines the final TA used by the terminal.

Thereafter, the network device and the terminal maintain consistency on the TA value of the UE, and the network device transmits a confirmation indication Msg4 to the terminal.

The network device determines the TA value of each terminal by measuring uplink transmission of the terminal. The network device transmits a timing advance command (TAC) to the terminal using at least one of the following methods to inform the terminal of the amount of time it needs to advance the uplink transmission.
Acquisition of initial TA: during the random access procedure, the network device determines the TA value by measuring the received preamble and transmits the TA value to the terminal through the TAC field of the RAR.
TA adjustment for terminals in RRC connected state: although the terminal achieves uplink synchronization with the network device during the random access procedure, the timing of the uplink signal arriving at the network device may change over time. Therefore, the terminal needs to continuously update the TA to maintain uplink synchronization. Where the TA for a terminal needs alignment, the network device may transmit a TAC to the terminal, to request the terminal to adjust the TA. The TAC is transmitted to the terminal in the form of a MAC CE.

Illustratively, referring to FIG. 8, which illustrates a flowchart of a method for determining a TA according to some embodiments of the present disclosure, the method includes:

In S810, a first TA is determined based on a free-space path loss between the terminal and the satellite.

In some embodiments, the free-space path loss refers to the loss of electromagnetic wave signal strength during propagation in telecommunications. The loss is caused by the line-of-sight path through free space, because there are no obstacles in the propagation range that may cause reflection or diffraction during propagation.

In some embodiments, the types of satellites include at least one of LEO, GEO, or HEO, which is not limited herein.

In an achievable scenario, the terminal includes a first terminal, and the first terminal determines the first TA corresponding to the first terminal through the free-space path loss between itself and the satellite.

Optionally, the parameters included in the first TA include one of:
a TA for the service link;
a path loss assistance value N_{TAoffset} broadcast by the network device to the terminal;
a TA adjustment value N_{TA}; or
a TA value N_{TA,adj}^{common} between the satellite and the reference point RP.

It is worth noting that the first TA mentioned above may only include the TA for the service link; or the first TA mentioned above may include the sum of at least one other parameter in addition to the TA for the service link, with the TA for the service link.

In some embodiments, the TA for the service link is acquired based on the free-space path loss between the terminal and the satellite.

In some embodiments, the TA for the service link is acquired based on a distance between the terminal and the satellite; wherein the distance between the terminal and the satellite is acquired based on the free-space path loss between the terminal and the satellite.

In some embodiments, the distance between the terminal and the satellite is acquired based on a frequency point of a serving cell and the free-space path loss.

Illustratively, the distance between the terminal and the satellite is acquired through a distance calculation formula.

In some embodiments, the free-space path loss is acquired based on the first path loss value; wherein the first path loss value is calculated based on a measurement result of the serving cell.

In some embodiments, the first path loss value is equal to a reference signal transmit power of the serving cell minus a reference signal measurement result of the serving cell.

In some embodiments, the free-space path loss is equal to the first path loss value minus a path loss assistance value.

The path loss assistance value includes at least one of:
an atmospheric attenuation path loss value;
an ionospheric or tropospheric path loss value; or
a building path loss value.

In some embodiments, the path loss assistance value includes: a path loss assistance value corresponding to a reference terminal type; or a path loss assistance value corresponding to a reference terminal type, and an offset value between the reference terminal type and other terminal types; wherein the other terminal types refer to the terminal types other than the reference terminal type of at least two terminal types.

In some embodiments, the at least two terminal types include at least one of:
terminal types with different antenna gains; or
terminal types with different antenna polarization directions, wherein the antenna polarization directions include linear polarization or circular polarization.

In some embodiments, the first TA is determined based on the free-space path loss between the terminal and the satellite in a case where a constraint condition is satisfied.

In some embodiments, the constraint condition includes at least one of:
a line-of-sight path being present between the terminal and the satellite; or
the terminal being located in an outdoor scenario.

In some embodiments, the TA for the service link is acquired from the TA estimated by the terminal and the path loss assistance value.

In summary, in the TA determination method provided in the present disclosure, a TA for a service link is estimated by means of a free-space path loss between a terminal and a satellite, such that the terminal acquires a TA value without relying on positioning capabilities, thereby solving the problem that it is impossible to determine the TA value when the terminal does not have the positioning capabilities or the position of the terminal fails to be acquired at the position of the terminal by means of the positioning capabilities. Moreover, a reference signal measurement result of the terminal and the free-space path loss are used to estimate the TA for the service link, such that the terminal without the positioning capabilities is also capable of accessing an NTN cell, thereby reducing the manufacturing cost of the terminal, and eliminating the need for an integrated positioning module in the design of the terminal.

The following is a detailed description of the acquisition process of the first TA.

In S910, the terminal acquires a measurement result of the serving cell.

The measurement result of the serving cell includes a reference signal transmit power of the serving cell and a reference signal measurement result of the serving cell.

In some embodiments, a terminal preparing to access an NTN cell performs radio resource management (RRM) measurement by synchronizing with the downlink signal of the serving cell, thereby measuring the reference signal received power (RSRP) of the serving cell as the reference signal measurement result of the serving cell.

In some embodiments, the terminal uses the transmit power of the synchronization signal block (SSB) of the serving cell as the measurement result of the reference signal of the serving cell. Illustratively, the SSB measurement result of the serving cell is acquired based on the transmit power parameter ss-PBCH-BlockPower broadcast in the system message transmitted by the network device, that is, the ss-PBCH-BlockPower is used as the reference signal measurement result of the serving cell.

In some embodiments, the system messages include at least one a master information block (MIB) message or a system information block (SIB) message. The SIB message may be implemented as any one of SIB1, SIB2, SIB3, SIB4, SIB5, SIB6, SIB7, SIB8, and SIB9.

In S920, the terminal acquires the first path loss value based on the difference between the reference signal transmit power of the serving cell and the reference signal measurement result of the serving cell.

In some embodiments, the first path loss value is equal to the reference signal transmit power of the serving cell minus the reference signal measurement result of the serving cell.

Illustratively, when the first path loss value is acquired from the reference signal transmit power of the serving cell and the reference signal measurement result of the serving cell, the first path loss value is acquired by subtracting the reference signal measurement result of the serving cell from the reference signal transmit power of the serving cell. For the specific calculation process, refer to formula 1 below.

$$PL 1 = ss - PBCH - BlockPower - RSRP \qquad Formula 1$$

PL1 represents the first path loss value; ss-PBCH-BlockPower represents the reference signal transmit power of the serving cell; and RSRP represents the reference signal measurement result of the serving cell.

The first path loss value is used to indicate the difference between the reference signal transmit power and the reference signal received power of the serving cell, thereby determining the loss value generated during the transmission and reception of the reference signal of the serving cell, that is, the total loss value between the satellite and the terminal.

In S930, the terminal acquires the second path loss value, that is, the free-space path loss, based on the difference between the first path loss value and the path loss assistance value.

In some embodiments, when the free-space path loss is derived from the first path loss value, the free-space path loss is equal to the first path loss value minus the path loss assistance value. Illustratively, for calculation for the free-space path loss, reference may be made to Formula 2 hereinafter.

$$PL 2 = PL 1 - path loss assistance value \qquad Formula 2$$

PL2 represents the second path loss value, that is, the free-space path loss; and PL1 represents the first path loss value.

The path loss assistance value includes at least one of: an atmospheric attenuation path loss value; an ionospheric or tropospheric path loss value; a building path loss value; an antenna pointing loss; or a polarization loss.

The atmospheric attenuation path loss value refers to the loss caused by dry air and water vapor during the propagation of electromagnetic waves in the atmosphere.

The ionospheric or tropospheric path loss value refers to the path loss caused by irregular short-term changes in signal amplitude, phase, angle of arrival, polarization state, or the like, due to the influence of inhomogeneity and random time-variability of the ionospheric or tropospheric structure when electromagnetic waves pass through the ionosphere or troposphere, resulting in ionospheric or tropospheric scintillation.

The building path loss value refers to the path loss caused by the reflection of part of the electromagnetic waves when the waves pass through buildings because the buildings block the propagation path during the propagation of electromagnetic waves.

The antenna pointing loss refers to the loss caused by the fact that the antenna pointing of the terminal often deviates from the actual direction due to beam pointing caused by atmospheric refraction and other reasons.

The polarization loss refers to the reduction in a received signal level caused by mismatching between the polarization of the transmit antenna and the polarization of the receive antenna, which is called polarization error loss. Optionally, when the transmit antenna refers to the antenna on the satellite, the antenna installed on the terminal is the transmit antenna; when the transmit antenna refers to the antenna installed on the terminal, the antenna on the satellite is the transmit antenna.

Optionally, the path loss assistance value includes the sum of one or more of the above-mentioned types of path loss assistance values. In some embodiments, when the path loss assistance value includes the atmospheric attenuation path loss value, the ionospheric or tropospheric path loss value, and the building path loss value, for calculation of the free-space path loss, reference may be made to Formula 3 hereinafter.

$${PL}_{2} = {PL}_{1} - {PL}_{g} - {PL}_{s} - {PL}_{ε} \qquad Formula 3$$

PL₂ represents the free-space path loss, PL₁ represents the first path loss value, PL_{g} represents the atmospheric attenuation path loss value, PLₛ represents the ionospheric or tropospheric path loss value, and PL_{ε} represents the building path loss value.

In some embodiments, the values of the path loss assistance values listed above may be determined by the terminal; or may be set by the protocol; or may be determined by the network device. In a case where the values are determined by the network device, the network device transmits the values to the terminal via the system messages or RRC-specific signaling. That is, the path loss assistance information is information acquired via configuration.

In some embodiments, in a case where the terminal types are different, the path loss assistance values corresponding to terminals of different types are also different.

In S940, the terminal determines the distance between the terminal and the satellite based on the frequency point of the serving cell and the free-space path loss.

In some embodiments, the distance between the terminal and the satellite is acquired based on the frequency point of the serving cell and the free-space path loss.

In some embodiments, the serving cell includes at least one of a primary serving cell or a secondary serving cell.

Illustratively, the frequency point of the serving cell refers to the frequency number where the single side band (SSB) defining the serving cell is located. The serving cell here refers to the cell with which the terminal has data transmission.

In some embodiments, the distance between the terminal and the satellite is calculated through a distance calculation model, and reference may be made to Formula 4 as follows:

$$d = {10}^{\frac{( PL 2 - 32.45 - 20 lg ( fc ) )}{20}} \qquad Formula 4$$

PL2 represents the free-space path loss, fc represents the frequency point of the serving cell, and 32.45 is a specified value stipulated by the protocol.

In S950, the terminal acquires the TA for the service link based on the distance between the terminal and the satellite.

In some embodiments, the TA estimated by the terminal itself is acquired based on the distance between the terminal and the satellite.

Illustratively, when the TA estimated by the terminal is related to the distance between the terminal and the satellite, for calculation of the TA estimated by the terminal, reference may be made to Formula 5 hereinafter:

$${N}_{TA , adj}^{UE} = \frac{2 d}{c} \qquad Formula 5$$

d represents the distance between the terminal and the satellite, and c represents the speed of light.

That is, as seen from Formula 5, the variable related to the TA estimated by the terminal is the distance between the terminal and the satellite.

In S960, the terminal acquires the first TA based on the TA for the service link.

In some embodiments, the parameters included in the first TA include one of: a TA for the service link; a path loss assistance value N_{TAoffset} broadcast by the network device to the terminal; a TA adjustment value N_{TA}; or a TA value

$${N}_{TA , adj}^{common}$$

between the satellite and the reference point RP.

It is noteworthy that the first TA mentioned above may only include the TA for the service link; or the first TA mentioned above may include the sum of at least one other parameter in addition to the TA for the service link, with the TA for the service link.

In summary, in the TA determination method provided in the present disclosure, a TA for a service link is estimated by means of a free-space path loss between a terminal and a satellite, such that the terminal acquires a TA value without relying on positioning capabilities, thereby solving the problem that it is impossible to determine the TA value when the terminal does not have the positioning capabilities or the position of the terminal fails to be acquired at the position of the terminal by means of the positioning capabilities. Moreover, a reference signal measurement result of the terminal and the free-space path loss are used to estimate the TA for the service link, such that the terminal without the positioning capabilities is also capable of accessing an NTN cell, thereby reducing the manufacturing cost of the terminal, and eliminating the need for an integrated positioning module in the design of the terminal.

The following is a detailed description of the path loss assistance values corresponding to terminals of different types.

In some embodiments, the path loss assistance value includes: a path loss assistance value corresponding to a reference terminal type; or a path loss assistance value corresponding to a reference terminal type, and an offset value between the reference terminal type and other terminal types; wherein the other terminal types refer to the terminal types other than the reference terminal type of at least two terminal types.

Taking the terminal implemented as the first terminal as an example, in the first case, during configuring of the path loss assistance value by the network device, the network device directly configures the path loss assistance value according to the terminal type of the first terminal and transmits the first configuration result to the first terminal. That is, the current first configuration result includes the path loss assistance value corresponding to the first terminal type (in this case, the reference terminal is the first terminal). At this time, after receiving the first configuration result, the first terminal directly acquires the path loss assistance value corresponding to itself from the first configuration result.

Taking the terminal implemented as the first terminal as an example, in the second case, during configuring of the path loss assistance value by the network device, the network device first configures the path loss assistance value for the terminal type of the reference terminal to acquire the path loss assistance value corresponding to the reference terminal. Then, according to the difference in terminal types between the reference terminal and the first terminal, it determines the offset value between the path loss assistance value of the reference terminal and that of the first terminal. Thus, the path loss assistance value of the reference terminal and the offset value are sent to the first terminal as the second configuration result. That is, upon receiving the second configuration result, the first terminal acquires its corresponding path loss assistance value by adding the absolute value of the offset value to the path loss assistance value of the reference terminal in the second configuration result.

Illustratively, the terminal types include at least one of:
terminal types with different antenna gains;
terminal types with different antenna polarization directions, wherein the antenna polarization directions include linear polarization or circular polarization.

In some embodiments, the terminal types may include the antenna gain corresponding to the mobile phone antenna. For example, very small aperture terminals (VSAT) and mobile phones correspond to different antenna gains, and there is a −5.5-dB difference in antenna gain between mobile phone terminals and the VSATs; or, the terminal types may include the antenna polarization direction of the terminal. For example, linearly polarized terminals and circularly polarized terminals belong to different types of terminals, and mobile phones supporting linear polarization have a 3-dB polarization loss compared to mobile phones supporting circular polarization; or, the terminal types may include both antenna gain and antenna polarization direction. For example, terminal 1 is a terminal with linear polarization and −5.5-dB antenna gain.

Illustratively, Table 1 illustrates that different terminal types correspond to different path loss assistance values.

TABLE 1

| | Atmospheric | Ionospheric or | |
|---|---|---|---|
| | attenuation | tropospheric | Building |
| | path loss | path loss | path loss |
| | value (dB) | value (dB) | value (dB) |
| Reference terminal | 30 | 15 | 5 |
| (circularly polarized | | | |
| VSAT) | | | |
| Terminal 1 (circularly | 35.5 | 20.5 | 10.5 |
| polarized mobile | | | |
| phone) | | | |
| Terminal 2 (linearly | 38.5 | 23.5 | 13.5 |
| polarized mobile | | | |
| phone) | | | |

Therefore, as know from Table 1, taking the reference terminal and terminal 1 as examples, since the reference terminal type is a VSAT supporting circularly polarized antennas, and the terminal type of terminal 1 is a mobile phone terminal supporting circular polarization, the reference terminal and terminal 1 only differ in antenna gain, with an antenna gain difference of 5.5 dB.

Taking the reference terminal and terminal 2 as examples, since the terminal type of terminal 2 is a mobile phone terminal supporting linearly polarized antennas, there is not only a loss difference in antenna gain (i.e., 5.5 dB) between the reference terminal and terminal 2, but also a polarization loss (3 dB) corresponding to polarized antennas.

In some embodiments, during configuring of path loss assistance values for a plurality of terminals of different terminal types respectively, the network device may fully configure the corresponding path loss assistance values for each terminal; alternatively, the network device may only fully configure the path loss assistance value corresponding to the reference terminal for the reference terminal, and configure the offset value corresponding to the path loss assistance value for other terminals according to the difference between the terminal type corresponding to other terminals and the terminal type corresponding to the reference terminal. For details, reference may be made to Table 2.

TABLE 2

| | Atmospheric | Ionospheric or | |
|---|---|---|---|
| | attenuation | tropospheric | Building |
| | path loss | path loss | path loss |
| | value (dB) | value (dB) | value (dB) |
| Reference terminal | 30 | 15 | 5 |
| (circularly polarized | | | |
| VSAT) | | | |
| Offset value of the | 5.5 | 5.5 | 5.5 |
| terminal 1 (circularly | | | |
| polarized mobile | | | |
| phone) | | | |
| Offset value of the | 8.5 | 8.5 | 8.5 |
| terminal 1 (linearly | | | |
| polarized mobile | | | |
| phone) | | | |

Therefore, as know from Table 2, taking the atmospheric attenuation path loss values corresponding to the reference terminal and terminal 1 as examples, since the reference terminal is a VSAT supporting circularly polarized antennas and terminal 1 is a mobile phone terminal supporting circular polarization, the only difference between the reference terminal and terminal 1 lies in antenna gain, with an antenna gain difference of 5.5 dB. That is, the path loss assistance value received by terminal 1 includes the atmospheric attenuation path loss value corresponding to the reference terminal (30 dB) and the offset value corresponding to terminal 1 (5.5 dB). Terminal 1 calculates the actual atmospheric attenuation path loss value corresponding to itself by summing the atmospheric attenuation path loss value of the reference terminal and the offset value.

Taking the reference terminal and terminal 2 as examples, since terminal 2 is a mobile phone terminal supporting linearly polarized antennas, there is not only a loss difference in antenna gain (i.e., 5.5 dB) between the reference terminal and terminal 2, but also a polarization loss (3 dB) corresponding to polarized antennas. That is, the path loss assistance value received by terminal 2 includes the atmospheric attenuation path loss value corresponding to the reference terminal (30 dB), the first offset value corresponding to terminal 2 (5.5 dB), and the second offset value (3 dB). Terminal 2 calculates the actual atmospheric attenuation path loss value corresponding to itself by summing the atmospheric attenuation path loss value of the reference terminal, the first offset value, and the second offset value.

It is worth noting that in a case where the reference terminal and the first terminal belong to the same terminal type, no offset value is required.

In some embodiments, when the network device configures path loss assistance values for a plurality of terminals of different types respectively, the terminal type corresponding to the reference terminal for configuration needs to be clearly specified by the protocol. For example, when the path loss assistance value is the atmospheric path loss value, in a case where the parameter value broadcast by the network device to the terminal is for a terminal with circular polarization and a 0-dBi antenna gain, then the reference terminal type is a terminal with circular polarization and a 0-dBi antenna gain. Correspondingly, in a case where the first terminal has linear polarization and a −5.5-dB antenna gain, the actual atmospheric path loss value of the first terminal should be the broadcast atmospheric path loss value +3 dB+5.5 dB. That is, in a case where the first terminal has deviations from the reference terminal type in terms of antenna polarization direction/antenna gain, or the like, the first terminal may compensate the corresponding offset value to the path loss assistance value broadcast by the network device as the finally used path loss assistance value.

In summary, in the TA determination method provided in the present disclosure, a TA for a service link is estimated by means of a free-space path loss between a terminal and a satellite, such that the terminal acquires a TA value without relying on positioning capabilities, thereby solving the problem that it is impossible to determine the TA value when the terminal does not have the positioning capabilities or the position of the terminal fails to be acquired at the position of the terminal by means of the positioning capabilities. Moreover, a reference signal measurement result of the terminal and the free-space path loss are used to estimate the TA for the service link, such that the terminal without the positioning capabilities is also capable of accessing an NTN cell, thereby reducing the manufacturing cost of the terminal, and eliminating the need for an integrated positioning module in the design of the terminal.

In some embodiments, in a case where full setting is performed on the path loss assistance values of terminals of different terminal types, it is ensured that the terminals accurately receive their corresponding path loss assistance values, thereby improving the accuracy of the first TA value.

In some embodiments, in a case where full configuration of path loss assistance values is performed for the reference terminal, and offset values of path loss assistance values are configured for other terminals according to the differences in terminal types between other terminals and the reference terminal, the number of bits required in the configuration signaling is reduced, and the signaling configuration overhead is lowered.

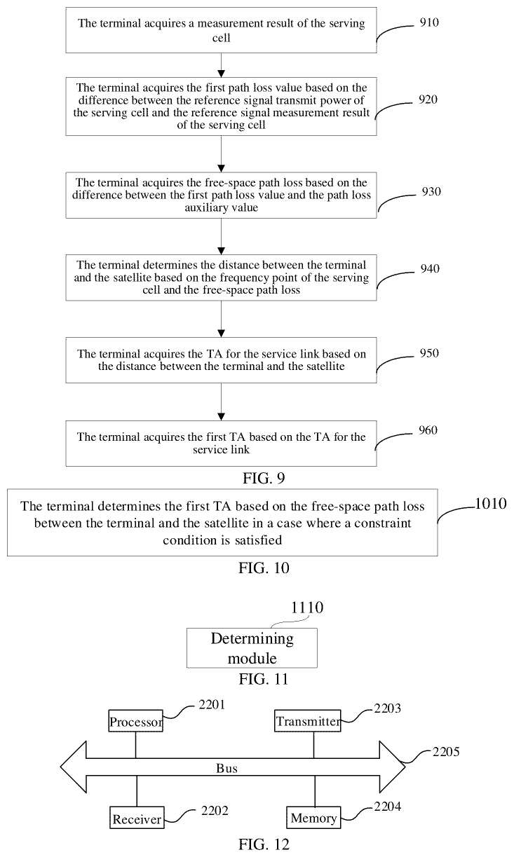

In an achievable scenario, the first TA is also related to restrictive conditions. Illustratively, referring to FIG. 10, which illustrates a flowchart of a method for determining a TA according to some embodiments of the present disclosure, the method includes the following steps.

In S1010, the terminal determines the first TA based on the free-space path loss between the terminal and the satellite in a case where a constraint condition is satisfied.

In some embodiments, a free-space path loss refers to the loss of electromagnetic wave signal strength during propagation in telecommunications. This loss is caused by the line-of-sight path through free space, because there are no obstacles in the propagation range that may cause reflection or diffraction during propagation.

In some embodiments, the types of satellites include at least one of LEO, GEO, or HEO, which is not limited herein.

In an achievable scenario, the terminal includes a first terminal, and the first terminal determines the first TA corresponding to the first terminal through the free-space path loss between itself and the satellite.

In some embodiments, the constraint condition includes at least one of: a line-of-sight path being present between the terminal and the satellite; the terminal being located in an outdoor scenario; or the number of antennas of the terminal.

In some embodiments, since the above method for calculating free-space path loss is acquired through the free-space path loss model (formula 3), when the terminal is in an indoor scenario, there may be a lack of line-of-sight propagation between the terminal and the satellite, which affects the model accuracy of the free-space path loss model. The line-of-sight path between the terminal and the satellite means that the electromagnetic waves between the terminal and the satellite propagate in a straight line without other multipath reflections.

Therefore, the first TA acquired via the RSRP measurement results in the above embodiments is applied only when there is a line-of-sight path between the terminal and the satellite and/or the terminal is in an outdoor scenario.

In some embodiments, the number of antennas installed in the terminal includes 1, 2, or more. Taking the numbers 1 and 2 as examples, in a case where a terminal is equipped with one antenna, the terminal has a single receive channel, and is regarded as a 1RX terminal; or in a case where a terminal is equipped with two antennas, the terminal has dual receive channels, and is regarded as a 2RX terminal.

In some embodiments, for 1RX terminals, such as 1RX reduced capability (RedCap) terminals or NR enhanced reduced capability (eRedCap) terminals, the accuracy of RSRP measurement results of such terminals is much lower than that of 2RX terminals. In this case, using the first TA derived from RSRP measurement results may lead to excessive errors, which in turn may cause failure of uplink synchronization of the terminal or increase interference during data transmission of the terminal on the uplink. Therefore, in the current scenario, 2RX terminals are suitable for the solutions according to the above embodiments.

In summary, in the TA determination method provided in the present disclosure, a TA for a service link is estimated by means of a free-space path loss between a terminal and a satellite, such that the terminal acquires a TA value without relying on positioning capabilities, thereby solving the problem that it is impossible to determine the TA value when the terminal does not have the positioning capabilities or the position of the terminal fails to be acquired at the position of the terminal by means of the positioning capabilities. Moreover, a reference signal measurement result of the terminal and the free-space path loss are used to estimate the TA for the service link, such that the terminal without the positioning capabilities is also capable of accessing an NTN cell, thereby reducing the manufacturing cost of the terminal, and eliminating the need for an integrated positioning module in the design of the terminal.

In addition, by adding restrictive conditions, the terminal may calculate the first TA more accurately, enabling the terminal to transmit signals to the network device at the correct time. This, in turn, reduces the signal interference caused by the terminal corresponding to the first TA to other terminals when the network device receives signals transmitted by different terminals.

It is worth noting that the above multiple embodiments are merely illustrative examples. The solutions according to the present disclosure may be implemented as all the enumerated results of embodiments acquired by splitting or combining the above embodiments.

The following are apparatus or device embodiments of the present disclosure, which may be used to implement the method embodiments of the present disclosure. For details not disclosed in the device embodiments of the present disclosure, reference may be made to the method embodiments of the present disclosure.

FIG. 11 illustrates a block diagram of an apparatus for determining a TA according to some embodiments of the present disclosure.

The apparatus includes: a determining module 1110, configured to determine a first TA based on a free-space path loss between the apparatus and a satellite.

In some embodiments, the first TA includes a TA for a service link; wherein the TA for the service link is acquired based on the free-space path loss between the apparatus and the satellite.

In some embodiments, the TA for the service link is acquired based on a distance between the apparatus and the satellite; wherein the distance between the apparatus and the satellite is acquired based on the free-space path loss between the apparatus and the satellite.

In some embodiments, the distance between the apparatus and the satellite is acquired based on a frequency point of a serving cell and the free-space path loss.

In some embodiments, the distance d between the apparatus and the satellite is calculated based on the following Formula 4:

$$d = {10}^{\frac{( PL 2 - 32.45 - 20 lg ( fc ) )}{20}} \qquad Formula 4$$

PL2 represents the free-space path loss, and fc represents the frequency point of the serving cell.

In some embodiments, the free-space path loss is acquired based on the first path loss value; wherein the first path loss value is calculated based on a measurement result of the serving cell.

In some embodiments, the first path loss value is equal to a reference signal transmit power of the serving cell minus a reference signal measurement result of the serving cell.

In some embodiments, the free-space path loss is equal to the first path loss value minus a path loss assistance value; wherein the path loss assistance value includes at least one of: an atmospheric attenuation path loss value, an ionospheric or tropospheric path loss value, or a building path loss value.

In some embodiments, the path loss assistance value includes: a path loss assistance value corresponding to a reference apparatus type; or a path loss assistance value corresponding to a reference apparatus type, and an offset value between the reference apparatus type and other apparatus types; wherein the other apparatus types refer to the apparatus types other than the reference apparatus type of at least two apparatus types.

In some embodiments, the at least two apparatus types include at least one of: apparatus types with different antenna gains; or apparatus types with different antenna polarization directions, wherein the antenna polarization directions include linear polarization antennas or circular polarization antennas.

In some embodiments, the determining module 1110 is configured to determine the first TA based on the free-space path loss between the apparatus and the satellite in a case where a constraint condition is satisfied.

In some embodiments, the constraint condition includes at least one of: a line-of-sight path being present between the apparatus and the satellite; or the apparatus being located in an outdoor scenario.

It should be noted that when the device provided in the above embodiment implements its functions, the division of the above functional modules is only used as an example for illustration. In practical applications, the above functions may be assigned to different functional modules according to actual needs, that is, the device may be designed into different functional modules to complete all or part of the functions described above.

Regarding the device in the above embodiment, the specific manner in which each module performs operations has been described in detail in the embodiment related to the method, and will not be elaborated here.

FIG. 12 illustrates a schematic structural diagram of a communication device provided by an embodiment of the present disclosure. The communication device may include: a processor 2201, a receiver 2202, a transmitter 2203, a memory 2204, and a bus 2205.

The processor 2201 includes one or more processing cores, and the processor 2201 executes various functional applications and information processing by running software programs and modules.

The receiver 2202 and the transmitter 2203 may be implemented as a transceiver, which may be a communication chip.

The memory 2204 is connected to the processor 2201 via the bus 2205; illustratively, the processor 2201 may be implemented as a first IC chip, and the processor 2201 and the memory 2204 may be jointly implemented as a second IC chip; the first chip or the second chip may be an application specific integrated circuit (ASIC) chip.

The memory 2204 may be used to store at least one computer program, and the processor 2201 is configured to execute the at least one computer program, so as to implement each step performed by the access point multi-link device in the above method embodiments.

In addition, the memory 2204 may be implemented by any type of volatile or non-volatile storage device or a combination thereof. Volatile or non-volatile storage devices include but are not limited to: a random-access memory (RAM), a read-only memory (ROM), an erasable programmable read-only memory (EPROM), an electrically erasable programmable read-only memory (EEPROM), a flash memory or other solid-state storage devices, a compact disc read-only memory (CD-ROM), a digital video disc (DVD) or other optical storage devices, a magnetic tape cartridge, a magnetic tape, a magnetic disk storage device or other magnetic storage devices.

Some embodiments of the present disclosure provide a computer-readable storage medium configured to store one or more computer programs. The one or more computer programs, when loaded and run by a processor of a multi-link device, cause the multi-link device to perform the method for determining a TA.

In some embodiments, the computer-readable storage medium may include: a read-only memory (ROM), a random-access memory (RAM), a solid state drive (SSD), an optical disc, or the like. The random access-memory may include a resistance random-access memory (ReRAM) and a dynamic random-access memory (DRAM).

Some embodiments of the present disclosure provide a chip. The chip includes programmable logic circuitry and/or one or more program instructions. The chip, when running on a multi-link device, is configured to perform the method for determining a TA.

Some embodiments of the present disclosure provide a computer program product or a computer program. The computer program product or computer program includes computer instructions. The computer instructions are stored in a computer-readable storage medium. The one or more computer instructions, when loaded and executed by a processor of a multi-link device, cause the multi-link device to perform the method for determining a TA.

It should be understood that the “indication” mentioned in the embodiments of the present disclosure may be a direct indication, an indirect indication, or an indication of an associative relationship. For example, “A indicates B” may mean that A directly indicates B, for instance, B may be acquired via A; it may also mean that A indirectly indicates B, for example, A indicates C, and B may be acquired via C; it may also mean that there is an association between A and B.

In the description of the embodiments of the present disclosure, the term “correspondence” may indicate that there is a direct or indirect corresponding relationship between the two, or that there is an associative relationship between them, or it may refer to relationships such as indication and being indicated, configuration and being configured, or the like.

The term “a plurality of” mentioned herein refers to two or more. The term “and/or” describes the associative relationship between related objects, indicating that there may be three kinds of relationships. For example, the phrase “A and/or B” means (A), (B), or (A and B). The symbol “/” generally indicates an “or” relationship between the associated objects.

In addition, the step numbers described in this article only exemplarily show one possible execution order between steps. In some other embodiments, the above steps may not be executed in the order of the numbers. For example, two steps with different numbers may be executed simultaneously, or two steps with different numbers may be executed in the reverse order of that shown in the figures. The embodiments of the present disclosure do not limit this.

Those skilled in the art should realize that in one or more of the above examples, the functions described in the embodiments of the present disclosure may be implemented by hardware, software, firmware, or any combination thereof. When implemented by software, these functions may be stored in a computer-readable medium or transmitted as one or more instructions or codes on a computer-readable medium. Computer-readable media include computer storage media and communication media, where communication media include any medium that facilitates the transfer of computer programs from one place to another. A storage medium may be any available medium accessible by a general-purpose or special-purpose computer.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

The above are only exemplary embodiments of the present disclosure and are not intended to limit the present disclosure. Any modifications, equivalent replacements, improvements, or the like made within the spirit and principles of the present disclosure shall be included in the protection scope of the present disclosure.

1. A method for determining a timing advance (TA), comprising:
determining a first TA based on a free-space path loss between a terminal and a satellite.

2. The method according to claim 1, wherein the first TA comprises a TA for a service link;
wherein the TA for the service link is acquired based on the free-space path loss between the terminal and the satellite.

3. The method according to claim 2, wherein the TA for the service link is acquired based on a distance between the terminal and the satellite;
wherein the distance between the terminal and the satellite is acquired based on the free-space path loss between the terminal and the satellite.

4. The method according to claim 3, wherein the distance between the terminal and the satellite is acquired based on a frequency point of a serving cell and the free-space path loss.

5. The method according to claim 4, wherein the distance between the terminal and the satellite is calculated based on the following formula:
$$d = {10}^{\frac{( PL 2 - 32.45 - 20 lg ( fc ) )}{20}} ;$$
wherein d represents the distance between the terminal and the satellite, PL2 represents the free-space path loss, and fc represents the frequency point of the serving cell.

6. The method according to claim 4, wherein the free-space path loss is acquired based on a first path loss value; wherein the first path loss value is calculated based on a measurement result of the serving cell.

7. The method according to claim 6, wherein the first path loss value is equal to a reference signal transmit power of the serving cell minus a reference signal measurement result of the serving cell.

8. The method according to claim 6, wherein the free-space path loss is equal to the first path loss value minus a path loss assistance value;
wherein the path loss assistance value comprises at least one of: an atmospheric attenuation path loss value, an ionospheric or tropospheric path loss value, or a building path loss value.

9. The method according to claim 8, wherein the path loss assistance value comprises:
a path loss assistance value corresponding to a reference terminal type; or
a path loss assistance value corresponding to a reference terminal type, and an offset value between the reference terminal type and other terminal types;
wherein the other terminal types refer to terminal types other than the reference terminal type from at least two terminal types.

10. The method according to claim 9, wherein the at least two terminal types comprise at least one of:
terminal types with different antenna gains; or
terminal types with different antenna polarization directions, wherein the antenna polarization directions comprise linear polarization or circular polarization.

11. A communication device, comprising: a processor and a memory storing at least one segment of program; wherein the processor is configured to execute the at least one segment of program in the memory to determine a first timing advance (TA) based on a free-space path loss between a terminal and a satellite.

12. The communication device according to claim 11, wherein the first TA comprises a TA for a service link;
wherein the TA for the service link is acquired based on the free-space path loss between the communication device and the satellite.

13. The communication device according to claim 12, wherein the free-space path loss is acquired based on the first path loss value; wherein the first path loss value is calculated based on a measurement result for the serving cell.

14. The communication device according to claim 13, wherein the first path loss value is equal to a reference signal transmit power of the serving cell minus a reference signal measurement result for the serving cell.

15. The communication device according to claim 13, wherein the free-space path loss is equal to the first path loss value minus a path loss assistance value;
wherein the path loss assistance value comprises at least one of: an atmospheric attenuation path loss value, an ionospheric or tropospheric path loss value, or a building path loss value.

16. The communication device according to claim 15, wherein the path loss assistance value comprises:
a path loss assistance value corresponding to a reference communication device type; or
a path loss assistance value corresponding to a reference communication device type, and an offset value between the reference communication device type and other communication device types;
wherein the other communication device types refer to communication device types other than the reference communication device type from at least two communication device types.

17. The communication device according to claim 16, wherein the at least two communication device types comprise at least one of:
communication device types with different antenna gains; or
communication device types with different antenna polarization directions, wherein the antenna polarization directions comprise linear polarization or circular polarization.

18. The communication device according to claim 11, wherein the determination module is configured to determine the first TA based on the free-space path loss between the communication device and the satellite in a case where a constraint condition is satisfied.

19. The communication device according to claim 17, wherein the constraint condition comprises at least one of:
a line-of-sight path being present between the communication device and the satellite; or
the communication device being located in an outdoor scenario.

20. A chip, comprising: programmable logical circuitry or one or more programs; wherein the chip, when running, is caused to:
determine a first timing advance (TA) based on a free-space path loss between a terminal and a satellite.
